(19) United States
(12) Patent Application Publication
(10) Pub. No.: US 2026/0228854 A1
(43) Pub. Date: Aug. 6, 2026

(54) LOW POWER CONFIGURABLE WARP PERSPECTIVE ACCELERATOR

(71) Applicant: NVIDIA Corporation, Santa Clara, CA (US)

(72) Inventors: Muya Chang, Bellevue, WA (US); Rangharajan Venkatesan, Santa Clara, CA (US); Thierry Tambe, Palo Alto, CA (US); Brucek Khailany, West Lake Hills, TX (US)

(21) Appl. No.: 19/043,059

(22) Filed: Jan. 31, 2025

(51) Int. Cl. G06T 3/18; G06T 1/20; G06T 3/4007

(52) U.S. Cl. CPC G06T 3/18; G06T 1/20; G06T 3/4007

(57) ABSTRACT

The disclosure provides a hardware implemented solution for warp perspective. The disclosed warp perspective accelerator (WPA) provides improved latency and energy efficiency compared to existing software solutions. In addition to the WPA, a method of warping an image using warping hardware is disclosed. In one example, the method includes: (1) receiving an instruction to warp a source image from a computer vision application or a controller, (2) determining a source coordinate of the source image based on a destination coordinate of a destination image and a transformation matrix, (3) computing a destination value for a pixel of the destination image at the destination coordinate based on source values of one or more pixels of the source image associated with the source coordinate, and (4) sending a memory write request for the destination value to a memory, wherein at least the determining and the computing are performed by the warping hardware.

### TECHNICAL FIELD

This application is directed, in general, to computer vision, and more specifically, to perspective warping in computer vision applications.

### BACKGROUND

In many computer-vision related applications, even though a large portion of the end-to-end pipeline has morphed into deep learning (DL) networks, some portions remain as traditional computer vision (CV) algorithms. Because deep learning accelerators (DLA) have been improved in recent years, such traditional CV algorithms can become the bottlenecks of an end-to-end vision pipeline due to Amdahl's law. A great example of such a task is warp perspective.

### SUMMARY

In one aspect, the disclosure provides a warp perspective accelerator (WPA). In one example, the WPA includes: (1) one or more registers configured to store resolution information for a source image and a destination image, and (2) warping hardware configured to perform a warping operation on the source image to obtain the destination image, wherein the warping operation determines a source coordinate of the source image based on a destination coordinate of the destination image and a transformation matrix, compute four neighboring areas based on the source coordinate and four neighboring coordinates of the source coordinate, and determine a destination value for a pixel at the destination coordinate based on the four neighboring areas and a source value of each pixel at the four neighboring coordinates.

In yet another aspect, the disclosure provides an integrated circuit (IC). In one example, the IC includes: (1) one or more processors to perform operations that include executing a CV task using a machine learning application and (2) a WPA having warping hardware configured to perform a warping operation on a source image to obtain a destination image for the CV task, wherein the warping operation determines a source coordinate of the source image based on a destination coordinate of the destination image and a transformation matrix, and computes a destination value for a pixel of the destination image at the destination coordinate based on source values of one or more pixels of the source image associated with the source coordinate.

In still another aspect, the disclosure provides a method of warping an image using warping hardware. In one example, the method includes: (1) receiving an instruction to warp a source image from a computer vision application or a controller, (2) determining a source coordinate of the source image based on a destination coordinate of a destination image and a transformation matrix, (3) computing a destination value for a pixel of the destination image at the destination coordinate based on source values of one or more pixels of the source image associated with the source coordinate, and (4) sending a memory write request for the destination value to a memory, wherein at least the determining and the computing are performed by the warping hardware

### BRIEF DESCRIPTION OF THE DRAWINGS

FIG. 1 illustrates a block diagram of an example of a CV pipeline including a warp perspective accelerator (WPA) constructed according to the principles of the disclosure;

FIG. 2 illustrates a block diagram of an integrated circuit (IC) having a WPA constructed according to the principles of the disclosure;

FIG. 3 illustrates a block diagram of an example of a WPA constructed according to the principles of the disclosure that shows various inputs and outputs;

FIG. 4 illustrates a diagram showing an example of an architecture of a WPA constructed according to the principles of the disclosure; and

FIG. 5 illustrates a flow diagram of an example method of warping an image using warping hardware.

### DETAILED DESCRIPTION

Typically, warp perspective is implemented as a software solution using warp perspective algorithms running on embedded processors located on a system-on-a-chip (SoC). In addition to programming, software solutions for warp perspective often require compiling of code from a library, such as the OpenCV C++ library, to a microprocessor or a Very Long Instruction Word (VLIW) digital signal processor (DSP). Such approaches rely on capable compilers and/or specialized central processing units (CPUs). However, these solutions have shortcomings including: 1. Energy per instruction overheads in programmable processors can be high compared to the energy performing the mathematical computations. 2. Default datatypes (examples include double precision floating point formats FP64 and FP32, and signed integer formats INT32 and INT64) are not as energy efficient as lower-precision floating-point or fixed-point datatypes and are often overkill for traditional CV tasks such as warp perspective.

To address at least the above noted problems, the disclosure provides a hardware implemented solution for warp perspective, a warp perspective accelerator (WPA). The disclosed WPA provides improved latency and energy efficiency compared to existing software solutions by, for example, recognizing the end-to-end vision applications to support and, therefore, the traditional CV tasks needed before the design and tapeout of an IC, such as a SoC. Accordingly, the WPA can be constructed as hardware accelerators, which can be customized to be more energy efficient on specific CV tasks than conventional software solutions.

The advantages provided by the disclosed WPA include, for example:
1. Hiding latency by pipelining the computation stages. A single instruction can be used in a pipeline fashion to compute warping for all of the pixels of an image.
2. Customizing bits needed for computation. Instead of a default format due to a processor, the number of bits used to represent values for the computations can be selected to provide a balance of both accuracy and efficiency. For example, 16 bits can be used in some applications to achieve the same accuracy compared to FP32. Essentially, the number of bits used can be preselected based on the application being accelerated, such as the disclosed warping algorithm.
3. Locating WPA close to memory. This allows fetching the required inputs and lowering the latency due to a low data-to-compute ratio. A single instruction can also be used to initiate computations in the WPA, wherein the single instruction can include multiple requests. Formatting of the instruction can be chosen based on the ISA (instruction set architecture). In a memory mapped IO, a processor can initiate the execution on WPA using a memory write instruction. In a custom instruction, a new instruction can be added to ISA for starting the execution on WPA. For example, after the host configures the WPA, it can execute a custom instruction to initiate the warping process.

Thus, the fetching and computing can be performed in an optimized manner compared to existing software solutions.

Accordingly, the WPA as disclosed herein provides a dedicated hardware solution that is configured to perform a specific function of warping. The WPA allows offloading the function or computation from a software application executing on a processor, such as a CPU. The WPA provides a more efficient option versus executing on software.

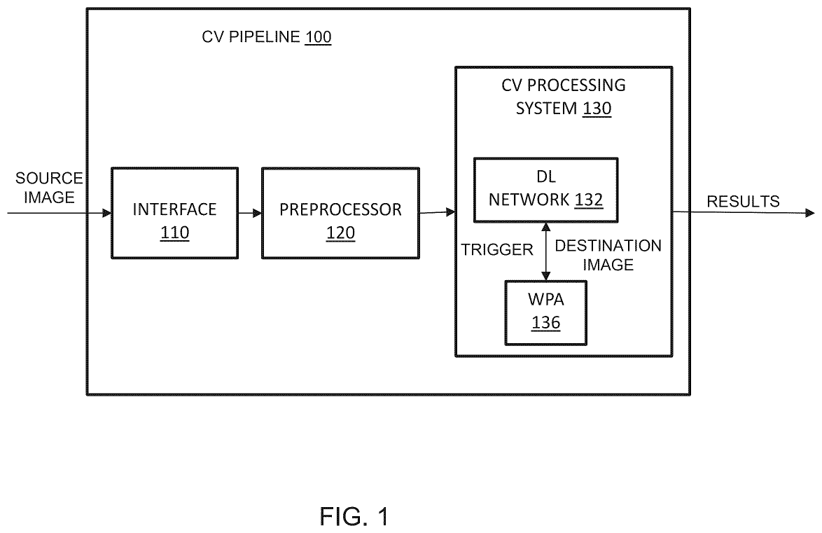

FIG. 1 illustrates a block diagram of an example of a CV pipeline 100 including a WPA constructed according to the principles of the disclosure. The CV pipeline 100 is configured to receive an image, process the image, and perform an action according to the processing of the image. Processing of the image can vary depending on the intended function of the CV pipeline 100. The CV pipeline 100 is implemented on a computing device, such as a laptop, a desktop, a computing tablet, a smartphone, or another type of mobile or stationary computing device. The CV pipeline includes an interface 110, a preprocessor 120, and a CV processing system 130.

The interface 110 is configured to receive a source image for processing. The source image can be acquired from a camera, either still or video, of a computing device, such as a mobile or stationary computing device noted above. The source image is a still image, such as a photograph or a frame of a video. The interface 110 can be a conventional interface that is configured to receive data, such as digital data of an image.

The preprocessor 120 is configured to preprocess the source image to, for example, enhance the image quality and/or extract relevant information before processing of the source image. The preprocessor 120 can denoise, contrast, and normalize the image data before processing. As such, the preprocessor 120 is configured to perform operations to prepare the source image for processing,

The CV processing system 130 is configured to perform processing of the preprocessed source image and generate a result according to the intended task of the processing. The intended task corresponds to the type of the CV processing system 130. For example, the CV processing system 130 may be directed to gaze detection, facial recognition, object detection, character recognition, etc. The result can be displaying an image, identifying an individual, identifying an object or character, etc.

The CV processing system 130 can employ one or more deep learning (DL) networks, as represented by DL network 132 in FIG. 1, to perform the intended task. The DL network 132 can be implemented on one or more processing units, such as a graphics processing unit (GPU), a central processing unit (CPU), or a combination thereof. The CV processing system 130 can also employ one or more DL accelerators with the one or more DL networks. In addition to the processing by the DL network 132, the CV processing system 130 also includes a WPA 136.

The WPA 136 is configured to perform a warping operation on the source image to obtain a destination image for the CV task performed by the DL network 132. The WPA 136 includes dedicated hardware designed to correct perspective distortion caused by camera misalignment with respect to the plane of the source image that was received by the interface 110. The WPA 136 and the DL network 132, or the entire CV pipeline 100, can be implemented on an IC.

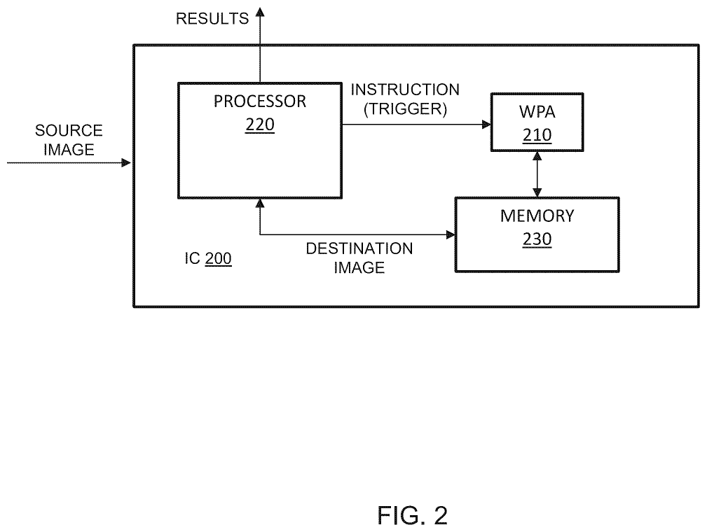

FIG. 2 illustrates a block diagram of an example of an IC 200 having a WPA 210 constructed according to the principles of the disclosure. In addition to the WPA 210, the IC 200 includes one or more processing units represented by processor 220 in FIG. 2, and a memory 230. The WPA 210, processor 220, and memory 230 can be a CV processing system such as CV processing system 130 in FIG. 1. The IC 200 can include additional circuits and components, such as ports that receive a source image to be processed and functional circuits configured to act on the output or results of the processor 220. The IC 200 can be part of a computing device, such as a mobile computing device. For example, the IC 200 can be part of a smart phone that also includes one or more cameras, a screen, a speaker, and a microphone. The IC 200 can be a SoC.

The WPA 210 includes warping hardware configured to perform a warping operation on a source image to obtain a destination image. The warping operation determines a source coordinate of the source image based on a destination coordinate of the destination image and a transformation matrix, The destination coordinate corresponds to a pixel of the destination image.

An example of a transformation matrix is represented by Equation 1 provided below.

$$dst ( x , y ) = src ( \frac{{M}_{11} x + {M}_{12} y + {M}_{13}}{{M}_{31} x + {M}_{32} y + {M}_{33}} , \frac{{M}_{21} x + {M}_{22} y + {M}_{23}}{{M}_{31} x + {M}_{32} y + {M}_{33}} )$$

In Equation 1, M is a 3×3 transformation matrix composed of real numbers and (x, y) is the destination coordinate. While the access pattern of destination coordinates is regular and deterministic, the access pattern of source coordinates is not. Accordingly, to calculate every source coordinate, multiple multiplications and divisions are required, which are performed more efficiently using the warping hardware of the WPA 210 compared to software solutions.

The warping operation determines a destination value for each pixel of the destination image based on one or more source values of pixels of the source image. The source coordinate determined by the transformation matrix, such as represented by Equation 1, may not correspond to a pixel of the source image and the destination value may need to be determined based on the source values of one or more source pixels. Determining the destination value can be a tradeoff between various factors, such as accuracy and efficiency. For example, the destination value can simply be deemed the value of the source pixel closest to the destination pixel. In some instances, interpolating using the values of multiple source pixels can be used for determining a destination value for a destination image pixel. Various interpolation strategies can be used, such as bilinear interpolation that calculates a weighted average of the values of four nearest source pixels to the destination pixel. In some examples, the weighted values of two or three source pixels closest to the destination pixel can be used. Instead of weighting the values, a simple average of the values of two, three, or four of the closest source pixels can be used.

The warping operation is performed for each pixel of the destination image. The warping operations for multiple of the pixels can be performed in parallel. For example, the warping hardware can be configured as a vectorized implementation that computes multiple destination values in parallel by computing multiple source indices and fetching multiple source pixel values. Additionally, the warping hardware can have a vectorized implementation that shares common source values across multiple destination value computations to save memory access energy. Compared to software solutions, the WPA 210 can also expend less energy when performing the warping operations since an optimized floating point format for the warping operations can be predetermined before tapeout. For example, the warping operations can be performed using 10 milliwatts or less of power at 60 frames per second.

In addition to warping hardware, the WPA 210 includes registers that are configured to store resolution information for the source image and the destination image. The resolution information at least includes the pixel dimensions of the source and destination image. For example, the source image can be a 3024×4032 pixel image and the destination image can be a 400×600 pixel image. The registers are further configured to receive a single instruction to initiate the warping operations. The single instruction can be a trigger signal and it can be received from the processor 220 or an external controller directing, for example, operation of the CV processing system.

The processor 220 executes a CV task using a machine learning application. The processor 220 can be a GPU. The CV task can be, for example, gaze detection. As such, in this example the WPA 210 can generate a destination image from the source image and provide the destination image to the processor 220 for gaze detection. The gaze detection application can be a power saving application that controls brightness of a screen based on detecting when a user is looking at the screen. For example, when detecting the user is looking at the screen, brightness of the screen can be increased and then decreased when the user is not looking at the screen. The IC 200 can be part of a stationary computing device or a mobile computing device, such as a smart phone.

The memory 230 can store data of the source image that is used during the warping operations. The data can be digital data that includes values of the source pixels that are used for determining the values of the destination pixels. The memory 230 can be a global scratchpad for multiple components of the IC 200, such as the processor 220.

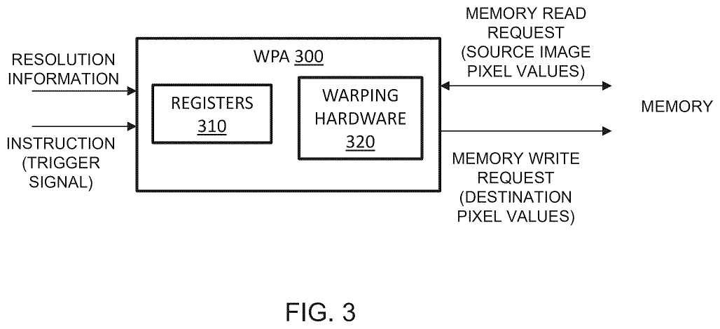

FIG. 3 illustrates a block diagram of an example of a WPA 300 constructed according to the principles of the disclosure that shows various inputs and outputs. The WPA 300 can be, for example, the WPA 136 or 210 of FIG. 1 or 2. The WPA 300 includes one or more registers represented by registers 310 in FIG. 3 and warping hardware 320.

Registers 310 are configured to store resolution information for a source image and a destination image and a transformation matrix that is used for warping. The registers 310 are further configured to receive a single instruction from the external program or controller to start the WPA 300. Registers 310 can be control and state registers (CSRs). The resolution information and the transformation matrix can be received from an external program or controller. The external program can be executing, for example, on the DL network 132 or processor 220 of FIGS. 1 and 2.

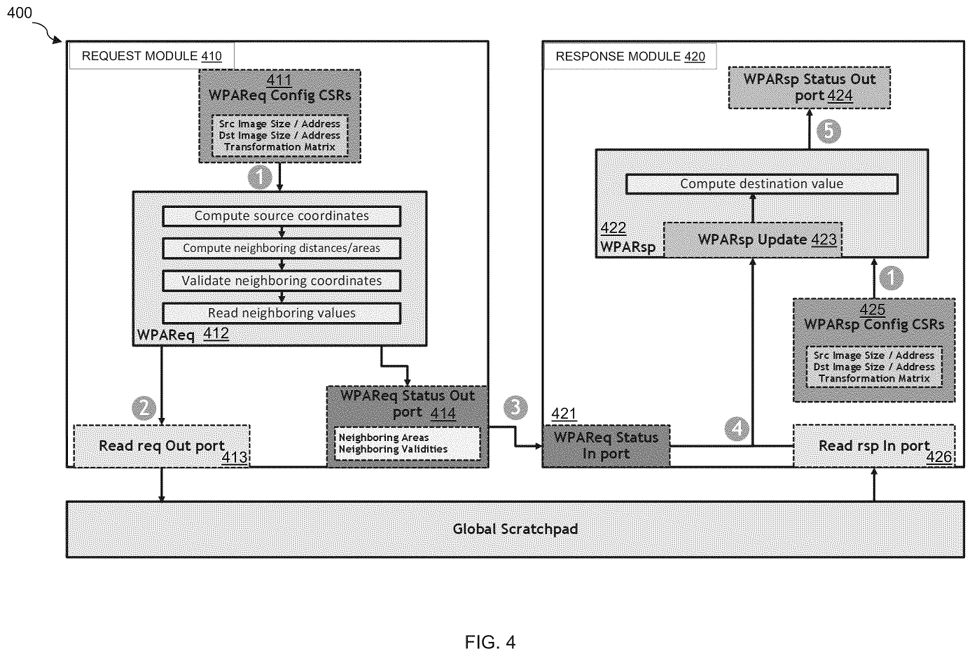

The warping hardware 320 is configured to perform a warping operation on the source image to obtain the destination image. The warping operation determines a destination value for each of the pixels of the destination image using the transformation matrix and source values of multiple pixels associated with each of the destination pixels. The warping hardware 320 receives the source image pixel values from a memory, such as memory 230 of FIG. 2, and writes the destination pixel values to the memory. A memory read request indicating the source image pixels or address of the source image pixels can be sent to the memory and the corresponding source image pixel values can be returned to the warping hardware for processing. The warping operation is initiated by an instruction or trigger signal. Advantageously, a single instruction can be received to initiate pipelined-computations of the warping operation for the complete source image. Multiple destination values can be determined in parallel by the warping hardware 320. The warping hardware 320 can request multiple source values in parallel by computing multiple source indices. Additionally, common source values can be shared across multiple destination value computations to save memory access energy. FIG. 4 illustrates an example of a WPA architecture with computations ordered along a pipeline. Considering FIG. 4, source values read from the memory are stored in a buffer 423 and processed to compute destination values. While computing multiple destination values in parallel, the shared source values are broadcast to hardware units 422 for processing. To enable temporal reuse of shared source values, a local register (not shown in the FIG. 4) may be used.

FIG. 4 illustrates a diagram showing an example of an architecture of a WPA 400 constructed according to the principles of the disclosure. The WPA 400 hardware configuration provides several contributions for processing an image. The contributions include a fixed-function hardware architecture for maximum energy efficiency. The architecture includes both a low bandwidth source buffer to handle random access patterns from the source image and a high bandwidth destination buffer to write back the results with a regular access pattern. Additionally, the warping hardware of the WPA 400 is fully pipelined to achieve high utilization of math units for energy efficiency. A simple ready-valid interface for accommodating latency-insensitive input/output is also provided with CS registers for high configurability work across a range of image sizes and warp transformation matrix. The hardware configuration also allows optimized numerics that include fixed-point quantization of key operations to save power and silicon area. Advantageously, design-time parameterization of datatypes and bit widths can also be used via the hardware design.

The WPA 400 includes multiple registers and warping hardware that is configured to perform a warping operation on the source image to obtain the destination image. The registers are CS registers configured to store resolution information for the source image and the destination image. The warping operation determines a source coordinate of the source image based on a destination coordinate of the destination image and a transformation matrix, such as represented by Equation 1.

The warped hardware uses bilinear interpolation to determine destination values for pixels of the destination image. For bilinear interpolation, the warping operation determines four neighboring coordinates of the source coordinate that correspond to pixels and four neighboring areas associated with the source coordinate and neighboring coordinates. The warping operation then determines a destination value for a pixel at the destination coordinate based on the four neighboring areas and a source value of each pixel at the four neighboring coordinates.

The warping hardware is split into a request module 410 and a response module 420, wherein the request module 410 is configured to determine the source coordinate, compute the four neighboring areas, and provide the neighboring areas to the response module 420. The response module 420 determines the destination value and writes the destination value to a memory, which can be a global scratchpad as indicated in FIG. 4. Multiple destination values can be determined in parallel and can be written to memory. The destination values can be used for further processing by a CV processing system, such as by the DL network 132 or the processor 220 of the CV processing systems of FIGS. 1 and 2. The destination values can be obtained for further processing either before or after all of the destination values of the destination image are computed. As such, all of the destination values can be computed before further processing is started.

The request module 410 includes a WPA request register (WPA-Req) 411, request warping hardware (WPAReq) 412, a read-request output port 413, and a request status output port 414.

The response module 420 includes a request status input port 421, response warping hardware (WPARsp) 422, a response status output port 424, a WPA response register (WPA-Rsp) 425, and a read response input port 426. The WPARsp 422 includes an WPA response update buffer 423 that stores WPA request status and read response.

An example operation proceeds as follows as indicated by the numbers 1 through 5 in FIG. 4. In a first step, an external program or controller configures the WPA-Req 411 and WPA-Rsp registers 425 and triggers them to start. Both the WPA-Req 411 and WPA-Rsp registers 425 are CSR registers and are configured with resolution information for the source image and the destination image. Both the WPA-Req 411 and WPA-Rsp registers 425 are also configured with the transformation matrix and the addresses of the source image and the destination image. The information stored on the WPA-Req 411 and WPA-Rsp registers 425 are used by the WPAReq 412 and the WPARsp 423 for computation. Once triggered, the WPAReq 412 performs operations along a pipeline as shown in FIG. 4.

For example, one or more destination pixels and source coordinates can be used by WPAReq 412 to compute source coordinates for a destination pixel, compute neighboring distances/areas, and validate neighboring distances/areas. For validation, a unique set of metadata is used for every destination pixel. Validation is beneficial since given a transformation matrix and destination indices, a location, for example (−1, 5), may be requested from the source image, which is illegal because all the indices should be non-negative. For such special cases, computing the neighboring distances and areas can be processed differently.

In a second step, the WPAReq 412 sends out memory read requests to read the values of source pixels determined in step 1. The read request can be directed to the global scratchpad using the address computed by WPAReq 412 from WPA-Req register 411 that was configured. The values of the source pixels can be provided to the response module 420 via the read response input port 426.

In a third step, the WPAReq 412 forwards the status data (i.e., the computing and validated neighboring areas and neighboring source pixels) to the response module 420 via the status output port 414 and the status input port 421.

In a fourth step, pairs of (status, data) are combined, updated, and provided to the WPARsp 422 via the response update buffer 423. The WPARsp 422 calculates the destination values for the destination pixels using the status and data from the response update buffer 423 and the information from the WPA-Rsp register 425. In a fifth step the WPARsp 422 sends out a memory write request periodically to the global scratchpad for the destination values that are provided to the status output port 424.

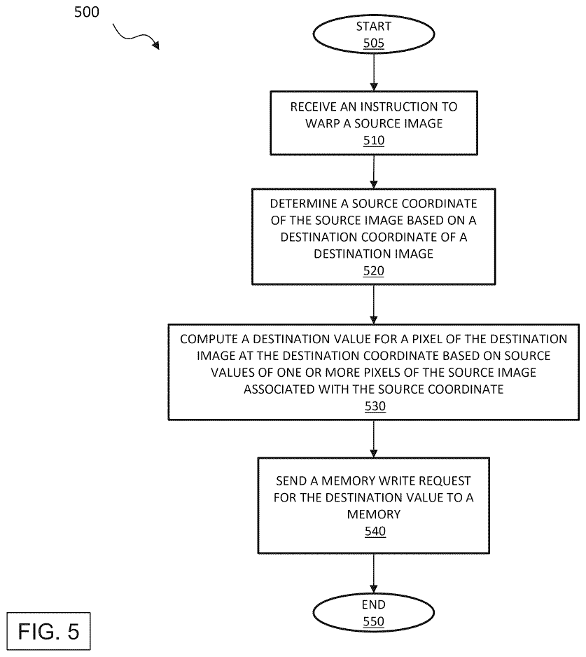

FIG. 5 illustrates a flow diagram of an example method 500 of warping an image using warping hardware. The warping hardware can be that of a WPA, such as WPA 136, WPA 210, or WPA 300, or WPA 400 as disclosed herein. Each of the steps of method 500 can be performed by the warping hardware. A format used by the warping hardware can be a floating-point format or a fixed-point format. Regardless, the format can be predetermined before construction of the warping hardware. The method 500 begins is a step 505.

In step 510, an instruction to warp a source image is received. The instruction can be received from a computer vision application executing on one or more processors, such as a gaze detection application. The instruction can also be received from a controller that is, for example, directing a computer vision process. The format used by the warping hardware can be different than the format used by the controller or processor. A single instruction can be used to initiate method 500.

A source coordinate of the source image is determined based on a destination coordinate of a destination image and a transformation matrix in step 520. The resolution of the destination image and the source image can vary. The source image can be received from a computing device, which includes the computing device having the warping hardware. The computing device can be a smart phone.

In step 530, a destination value for a pixel of the destination image at the destination coordinate is computed based on source values of one or more pixels of the source image associated with the source coordinate. The warping hardware can compute the destination value using bilinear interpolation. Both the determining and computing of steps 520 and 530 are performed for each pixel of the destination image. Advantageously, the determining and computing can be performed in parallel for multiple of the pixels of the destination image.

A memory write request for the destination value is sent to a memory in step 540. As noted above, a destination value for each of the pixels of the destination image is computed and each of the destination values can be written to the memory for use by, for example, a computer vision application. Method 500 continues to step 550 and ends once all of the destination values are computed and written to memory.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

The digital data processors or computers can be comprised of one or more GPUs, one or more CPUs, one or more of other processor types, or a combination thereof. The digital data processors and computers can be located proximate each other, proximate an intelligent machine such as an AV, in a cloud environment, a data center, or located in a combination thereof. For example, some components can be located proximate the intelligent machine, such as a trained neural motion planner, and some components can be located in a cloud environment or data center, such as a neural motion planner that is being trained.

The GPUs can be embodied on a single semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on a single chip.

The processors or computers can be part of GPU racks located in a data center. The GPU racks can be high-density (HD) GPU racks that include high performance GPU compute nodes and storage nodes. The high performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that all require a massive compute intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as noted above are capable of delivering the performance required for training NNs for artificial intelligence and machine learning applications.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Configured or configured to means, for example, designed, constructed, or programmed, with the necessary logic and/or features for performing a task or tasks. A configured device, therefore, is capable of performing a particular task or tasks. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

It is noted that as used herein and in the appended claims, the singular forms “a”, “an”, and “the” include plural referents unless the context clearly dictates otherwise.

Various aspects of the disclosure can be claimed including the systems and methods. Each of the independent claims provided below may have one or more of the elements of the dependent claims presented below in combination.

Those skilled in the art to which this application relates will appreciate that other and further additions, deletions, substitutions and modifications may be made to the described embodiments.

What is claimed is:

1. A warp perspective accelerator (WPA), comprising:
one or more registers configured to store resolution information for a source image and a destination image;
warping hardware configured to perform a warping operation on the source image to obtain the destination image, wherein the warping operation determines a source coordinate of the source image based on a destination coordinate of the destination image and a transformation matrix, compute four neighboring areas based on the source coordinate and four neighboring coordinates of the source coordinate, and determine a destination value for a pixel at the destination coordinate based on the four neighboring areas and a source value of each pixel at the four neighboring coordinates.

2. The WPA as recited in claim 1, wherein the warping operation is performed according to a warping algorithm and the warping hardware is configured to operate using a floating point format or fixed-point format based on the warping algorithm.

3. The WPA as recited in claim 2, wherein the floating point format or fixed-point format is determined before tapeout of the WPA.

4. The WPA as recited in claim 1, wherein the warping hardware is further configured to retrieve the source values of the four neighboring pixels from a memory.

5. The WPA as recited in claim 1, wherein the warping hardware is configured to determine a destination value for each of the destination coordinates.

6. The WPA as recited in claim 5, wherein the warping hardware is configured to determine destination values for multiple of the destination coordinates in parallel.

7. The WPA as recited in claim 6, wherein the warping hardware is configured to share one or more common source values across multiple destination values computations.

8. The WPA as recited in claim 1, wherein an architecture of the warping hardware includes a request module and a response module, wherein the request module is configured to determine the source coordinate, compute the four neighboring areas, and provide the neighboring areas to the response side, wherein the response side determines the destination value and writes the destination value to a memory.

9. The WPA as recited in claim 1, wherein the one or more registers are control and state registers (CSRs) configured to receive the resolution information for the source image and the destination image from an external program or controller.

10. The WPA as recited in claim 9, wherein the one or more registers are further configured to receive a single instruction from the external program or controller to initiate the WPA.

11. An integrated circuit (IC), comprising:
one or more processors to perform operations including:
executing a computer vision (CV) task using a machine learning application; and
a warping perspective accelerator (WPA) having warping hardware configured to perform a warping operation on a source image to obtain a destination image for the CV task, wherein the warping operation determines a source coordinate of the source image based on a destination coordinate of the destination image and a transformation matrix, and computes a destination value for a pixel of the destination image at the destination coordinate based on source values of one or more pixels of the source image associated with the source coordinate.

12. The IC as recited in claim 12, wherein the CV task is gaze detection.

13. The IC as recited in claim 12, wherein the one or more processors includes at least one GPU.

14. The IC as recited in claim 12, wherein the IC is a system-on-a-chip (SoC).

15. The IC as recited in claim 12, wherein the warping hardware performs the warping operation using 10 milliwatts or less of power at 60 frames per second.

16. The IC as recited in claim 12, wherein the warping hardware computes the destination value by determining four neighboring areas based on the source coordinate and four neighboring coordinates of the source coordinate, and computes the destination value for the pixel at the destination coordinate based on the four neighboring areas and a source value of each pixel at the four neighboring coordinates.

17. The IC as recited in claim 12, wherein the warping hardware is configured to determine a destination value for each pixel of the destination coordinates of the destination image in parallel by computing multiple source coordinates for each of the multiple destination coordinates and fetching multiple source values for the multiple pixels at each of the multiple source coordinates.

18. The IC as recited in claim 18, wherein the warping hardware is configured to share one or more common source values across multiple destination values computations.

19. A mobile computing device including the IC as recited in claim 12.

20. A method of warping an image using warping hardware, comprising:
receiving an instruction to warp a source image from a computer vision application or a controller;
determining a source coordinate of the source image based on a destination coordinate of a destination image and a transformation matrix;
computing a destination value for a pixel of the destination image at the destination coordinate based on source values of one or more pixels of the source image associated with the source coordinate; and
sending a memory write request for the destination value to a memory, wherein at least the determining and the computing are performed by the warping hardware.

21. The method as recited in claim 21, wherein the determining and computing are performed for each pixel of the destination image.

22. The method as recited in claim 22, wherein the determining and computing are performed in parallel for multiple of the pixels of the destination image.

23. The method as recited in claim 21, wherein the computing is performed using bilinear interpolation.

24. The method as recited in claim 21, wherein a floating-point format or a fixed-point format for the determining and the computing are predetermined before construction of the warping hardware.

25. The method as recited in claim 25, wherein the instruction is received from a processor and the floating-point format or the fixed-point format for the warping hardware is different than a format of the processor.
